(19) United States
(12) Patent Application Publication
(10) Pub. No.: US 2022/0027575 A1
(43) Pub. Date: Jan. 27, 2022

(54) METHOD OF PREDICTING EMOTIONAL STYLE OF DIALOGUE, ELECTRONIC DEVICE, AND STORAGE MEDIUM

(71) Applicant: Beijing Baidu Netcom Science Technology Co., Ltd., Beijing (CN)

(72) Inventors: Zhenglin PAN, Beijing (CN); Jie BAI, Beijing (CN); Yi WANG, Beijing (CN)

(21) Appl. No.: 17/499,910

(22) Filed: Oct. 13, 2021

(30) Foreign Application Priority Data
Oct. 14, 2020 (CN) 202011098145.1

(51) Int. Cl. G06F 40/35; G06N 20/00

(52) U.S. Cl. CPC G06F 40/35; G06N 20/00

(57) ABSTRACT

The present disclosure provides a method of predicting an emotional style of a dialogue, an electronic device and a storage medium, which relate to fields of natural language processing, intelligent voice and deep learning. The method includes: acquiring a context of a dialogue to be processed, from a text containing the dialogue; acquiring a character information of the dialogue, wherein the character information indicates a speaker of the dialogue; and predicting the emotional style of the dialogue according to the acquired context and the acquired character information.

### CROSS-REFERENCE TO RELATED APPLICATIONS

This application is claims priority to Chinese Application No. 202011098145.1, filed on Oct. 14, 2020, which is incorporated herein by reference in its entirety.

### TECHNICAL FIELD

The present disclosure relates to a field of artificial intelligence, and in particular to a method of predicting an emotional style of a dialogue, an electronic device and a storage medium in fields of natural language processing, intelligent voice and deep learning.

### BACKGROUND

Audio novels having multiple emotional styles have received more and more attention in the market. Accordingly, it is desired to label (that is, predict) an emotional style of each dialogue in a novel.

At present, emotional style is usually extracted in a poor accuracy.

### SUMMARY

The present disclosure provides a method of predicting an emotional style of a dialogue, an apparatus of predicting an emotional style of a dialogue, an electronic device, and a storage medium

There is provided a method of predicting the emotional style of the dialogue, including:

acquiring a context of a dialogue to be processed, from a text containing the dialogue;

acquiring a character information of the dialogue, wherein the character information indicates a speaker of the dialogue; and

predicting the emotional style of the dialogue according to the context and the character information.

There is provided an electronic device, including:

at least one processor; and

a memory communicatively connected to the at least one processor, wherein the memory stores instructions executable by the at least one processor, and the instructions, when executed by the at least one processor, cause the at least one processor to implement the method described above.

There is provided a non-transitory computer-readable storage medium having computer instructions stored thereon, wherein the computer instructions are configured to cause a computer to implement the method described above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure.

FIG. 1 shows a flowchart of a first embodiment of a method of predicting an emotional style of a dialogue according to of the present disclosure.

FIG. 2 shows a flowchart of a second embodiment of a method of predicting an emotional style of a dialogue according to of the present disclosure.

FIG. 3 shows a schematic structural diagram of an apparatus 30 of predicting an emotional style of a dialogue according to some embodiments of the present disclosure.

FIG. 4 shows a block diagram of an electronic device for implementing a method of predicting an emotional style of a dialogue according to the embodiments of the present disclosure.

### DETAILED DESCRIPTION OF EMBODIMENTS

The exemplary embodiments of the present disclosure are described below with reference to the drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

In addition, it should be understood that the term “and/or” herein only describes an association relationship of associated objects, which means that there may be three relationships. For example, A and/or B may refer to only A, only B, as well as A and B. In addition, a symbol “/” herein generally indicates an “or” relationship of associated objects.

Generally, extracting an emotional style directly from a text has a poor accuracy. For example, for the following text:

```
          [ . . .
          “ I feel sad, too. ”
          Zhang San comforted the sad Li Si unkindly.
          . . .]
```

if the emotional style is extracted directly from “I feel sad, too”, “comfort”, or “sad Li Si”, the accuracy of the prediction result is low.

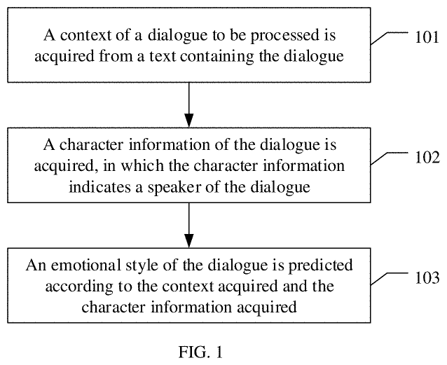

FIG. 1 shows a flowchart of a first embodiment of a method of predicting an emotional style of a dialogue according to the present disclosure. As shown in FIG. 1, the method includes following steps.

In step 101, a context of a dialogue to be processed is acquired from a text containing the dialogue.

In step 102, a character information of the dialogue is acquired, in which the character information indicates a speaker of the dialogue.

In step 103, an emotional style of the dialogue is predicted according to the acquired context and the acquired character information.

In the embodiments of the method described above, the emotional style of the dialogue may be predicted by using the context of the dialogue, the character information of the dialogue, and the like in combination, so that accuracy of the prediction result may be improved compared with an existing method. In addition, the text may be a text in any form, such as novel, news, script, etc., and has universal applicability.

In practical application, for a text to be processed, that is, the text containing the dialogue to be processed, dialogues in the text may be traversed to determine each of the dialogues as a dialogue to be processed. A specific order in which the dialogues in the text are traversed is not limited. For example, the dialogues in the text may be traversed from the beginning of the text to the end of the text.

In addition, the dialogue in the text may be recognized by determining a content within quotation marks in the text as the dialogue, and/or by determining, for any content in the text, whether the content is the dialogue, by using a pre-trained classification model.

The two ways of recognizing the dialogue may be achieved separately or in combination. For example, for the content within quotation marks in the text, it is possible to further determine whether the content is a dialogue by using the classification model. With dual recognition, the accuracy of the recognition result may be improved.

The above ways of recognizing the dialogue are only for illustration and are not used to limit the technical solution of the present disclosure. In practical application, any feasible way may be adopted. For example, the quotation marks may be other forms of symbols for representing a dialogue.

For the dialogue to be processed, the context of the dialogue may be acquired from the text containing the dialogue. The way of acquiring the context of the dialogue is not limited in the present disclosure. For example, M contents (M sentences) preceding the dialogue in the text and N contents following the dialogue in the text may be taken as a preceding text of the dialogue and a following text of the dialogue, respectively, so that the content of the dialogue is acquired. M and N are positive integers. The value of M may be the same as or different from the value of N, and the value of M and the value of N may be determined as desired in practice The preceding text of the dialogue, the dialogue, and the following text of the dialogue form a continuous text content.

In addition to the context of the dialogue, the character information of the dialogue, that is, information related to a speaker of the dialogue, may be further acquired. For example, the character information of the dialogue that is manually labeled may be acquired, or the character information of the dialogue may be predicted by using a pre-trained character prediction model. The specific way of acquiring the character information of the dialogue may be determined in a flexible and convenient manner, depending on practical requirements. However, in order to save labor costs, the latter way is preferred.

For example, for the following text:

```
          [ . . .
          “ I feel sad, too. ”
          Zhang San comforted the sad Li Si unkindly.
          . . .]
```

the character information of the dialogue “I feel sad, too” is “Zhang San.”

The character prediction model may be pre-trained. With this model, the character information corresponding to various dialogues may be predicted.

After the character information of the dialogue is acquired in any way as described above, the emotional style of the dialogue may be predicted according to the acquired context and character information.

Specifically, an input information, that contains the context of the dialogue, the character information of the dialogue and the dialogue, may be constructed and input into a pre-trained emotional style prediction model, so as to predict the emotional style of the dialogue.

A specific form of the input information is not limited in the present disclosure. For example, for the dialogue of “I feel sad, too”, the text content that contains the preceding text of the dialogue, the dialogue and the following text of the dialogue may be acquired, and the character information (generally appearing in the context of the dialogue) “Zhang San” in the text content may be labeled in a predetermined manner, so as to obtain the input information that contains the context of the dialogue, the character information of the dialogue and the dialogue.

The predetermined manner is not limited in the present disclosure. For example, a location of “Zhang San” may be specifically marked, or a specific character may be inserted at each of a position preceding “Zhang San” and a position following “Zhang San”.

After the input information is obtained, it may be input into the emotional style prediction model to predict the emotional style of the dialogue. The emotional style prediction model may calculate a probability value of the dialogue belonging to each of the emotional styles, and the emotional style corresponding to a greatest probability value may be predicted as the emotional style of the dialogue.

Compared with existing methods, the method described in the present disclosure may enable the model to acquire more information. For example, when it is determined that the speaker is “Zhang San”, the model may focus more on the context of “Zhang San”, so that there is a greater probability of extracting the emotional style from “unkindly”, so that the accuracy of the predicted emotional style may be improved.

As mentioned above, the emotional style prediction model may be pre-trained. Specifically, training samples may be constructed. Each training sample may correspond to a dialogue in a text, and may contain the input information for the dialogue and a label indicative of the emotional style of the dialogue. The input information for the dialogue is the input information that contains the context of the dialogue, the character information of the dialogue and the dialogue. Then, the emotional style prediction model may be pre-trained by using the training samples.

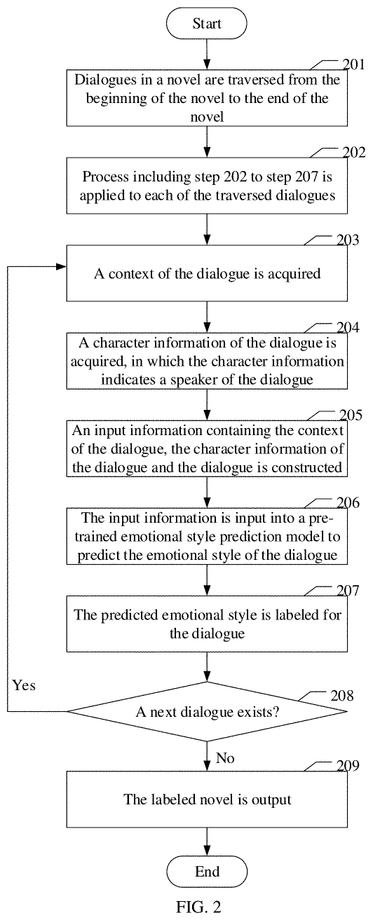

Based on the above introduction, FIG. 2 shows a flowchart of a second embodiment of a method of predicting an emotional style of a dialogue according to the present disclosure. As shown in FIG. 2, the method includes following steps.

In step 201, dialogues in a novel are traversed from the beginning of the novel to the end of the novel.

In this embodiment, it is assumed that the text to be processed is a novel.

In addition, a content within equation marks in the text may be determined as a dialogue, and/or for any content in the text, a pre-trained classification model may be used to determine whether the content is a dialogue.

In step 202, process including step 202 to step 207 is applied to each of the traversed dialogues.

In step 203, a context of the dialogue is acquired.

For example, M contents preceding the dialogue in the text and N contents following the dialogue in the text may be determined as a preceding text of the dialogue and a following text of the dialogue, respectively, so that the context of the dialogue is acquired. M and N are positive integers. The value of M may be the same as or different from the value of N.

In step 204, a character information of the dialogue is acquired, in which the character information indicates a speaker of the dialogue.

For example, the character information of the dialogue that is manually labeled may be acquired, or the character information of the dialogue may be predicted by using a pre-trained character prediction model.

In step 205, an input information containing the context of the dialogue, the character information of the dialogue and the dialogue is constructed.

Assuming that the character information exists in the context of the dialogue, the text content containing the preceding text of the dialogue, the dialogue and the following text of the dialogue may be acquired, and the character information in the text content may be labeled in a predetermined manner, so as to obtain the input information containing the context of the dialogue, the character information of the dialogue and the dialogue.

In step 206, the input information is input into a pre-trained emotional style prediction model to predict the emotional style of the dialogue.

Training samples may be pre-constructed. Each training sample may correspond to a dialogue in the text, and may contain the input information for the dialogue and a label indicative of the emotional style of the dialogue. Then, the emotional style prediction model may be pre-trained by using the training samples.

In step 207, the predicted emotional style is labeled for the dialogue.

In step 208, it is determined whether a next dialogue exists. If a next dialogue exists, the process returns to step 203 for the next dialogue. Otherwise, step 209 is performed.

In step 209, the labeled novel is output, and the process ends.

In the embodiments of the method described above, for each dialogue, the character information is acquired and is used together with the context to construct the input information. That is, the character information of the dialogue is added to the input of the model, so that the accuracy of the prediction result may be improved. Moreover, the process is very fast and efficient. It usually takes only a few minutes to label a novel with thousands of chapters, achieving an industrialized solution of predicting the emotional style of the dialogue.

It should be noted that for the sake of description, the embodiments of the method described above are all expressed as a series of actions, but those skilled in the art should know that the present disclosure is not limited by the described sequence of actions. According to the present disclosure, some steps may be performed in other order or simultaneously. Those skilled in the art should also know that the embodiments described in the specification are all preferred embodiments, and the involved actions and modules are not necessarily required by the present disclosure. In addition, for parts that are not described in detail in an embodiment, reference may be made to related descriptions of other embodiments.

The above is the description of the embodiments of the method. The solution of the present application is further described below by embodiments of apparatus.

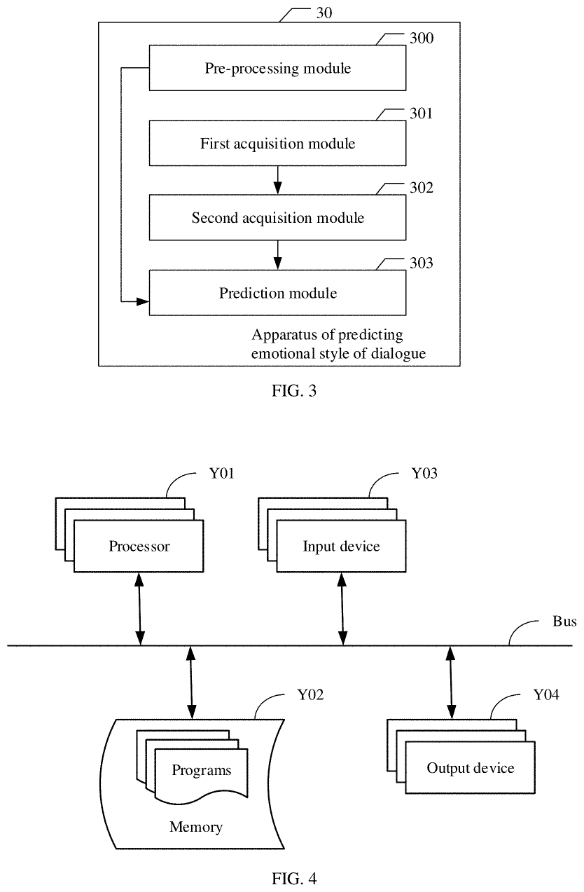

FIG. 3 shows a schematic structural diagram of an apparatus 30 of predicting an emotional style of a dialogue according to some embodiments of the present disclosure. As shown in FIG. 3, the apparatus 30 includes a first acquisition module 301, a second acquisition module 302, and a prediction module 303.

The first acquisition module 301 is used to acquire a context of a dialogue to be processed, from a text containing the dialogue.

The second acquisition module 302 is used to acquire character information of the dialogue. The character information indicates a speaker of the dialogue.

The prediction module 303 is used to predict the emotional style of the dialogue according to the acquired context and the acquired character information.

The first acquisition module 301 may traverse dialogues in the text to determine each of the dialogues as the dialogue to be processed. A specific order in which the dialogues in the text are traversed is not limited. For example, the dialogues in the text may be traversed from the beginning of the text to the end of the text.

The first acquisition module 301 may recognize the dialogue by determining a content within quotation marks in the text as the dialogue, and/or by determining, for any content in the text, whether the content is the dialogue, by using a pre-trained classification model. The two ways of recognizing the dialogue may be achieved separately or in combination. For example, for the content within quotation marks in the text, it is possible to further determine whether the content is a dialogue by using the classification model.

In addition, for the dialogue to be processed, the first acquisition module 301 may determine M contents preceding the dialogue in the text and N contents following the dialogue in the text as a preceding text of the dialogue and a following text of the dialogue, respectively, so that the context of the dialogue is acquired. The value of M may be the same as or different from the value of N.

When acquiring the character information of the dialogue, the second acquisition module 301 may acquire the character information of the dialogue that is manually labeled, or predict the character information of the dialogue by using a pre-trained character prediction model.

Further, after the context of the dialogue and the character information of the dialogue are acquired, the prediction module 303 may predict the emotional style of the dialogue according to the acquired context and the acquired character information. Specifically, input information that contains the context of the dialogue, the character information of the dialogue and the dialogue may be constructed and input into a pre-trained emotional style prediction model, so as to predict the emotional style of the dialogue.

For example, assuming that the character information exists in the context of the dialogue, the text content that contains the preceding text of the dialogue, the dialogue and the following text of the dialogue may be acquired, and the character information in the text content may be labeled in a predetermined manner, so as to obtain the input information containing the context of the dialogue, the character information of the dialogue and the dialogue.

The apparatus 300 shown in FIG. 3 may further includes a pre-processing module 300 used to construct training samples and pre-train the emotional style prediction model by using the training samples. Each training sample may correspond to a dialogue in the text, and may contain the input information for the dialogue and a label indicative of the emotional style of the dialogue.

For a specific workflow of the embodiments of the apparatus shown in FIG. 3, reference may be made to the related description in the embodiments of the method described above, which will not be repeated here.

In summary, by using the solutions described in the embodiments of the apparatus of the present disclosure, the emotional style of the dialogue may be predicted by using the context of the dialogue, the character information of the dialogue, and the like in combination, so that accuracy of the prediction result may be improved.

The solutions of the present disclosure may be applied to a field of artificial intelligence, and in particular relate to fields of natural language processing, intelligent voice and deep learning.

Artificial intelligence (AI) is a subject that studies how computers may simulate some human thinking processes and intelligent behaviors (such as learning, reasoning, thinking, planning, etc.), including both hardware and software technologies. AI hardware technology generally includes technologies such as sensors, special artificial intelligence chips, cloud computing, distributed storage, big data processing, and so on. AI software technology mainly includes computer vision technology, speech recognition technology, natural language processing technology and machine learning/deep learning, big data processing technology, knowledge graph technology, and so on.

Collecting, storing, using, processing, transmitting, providing, and disclosing etc. of the personal information of the user involved in the present disclosure all comply with the relevant laws and regulations, and do not violate the public order and morals.

According to the embodiments of the present disclosure, the present disclosure further provides an electronic device and a readable storage medium.

FIG. 4 shows a block diagram of an electronic device for implementing the method of predicting the emotional style of the dialogue according to the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 4, the electronic device may include one or more processors Y01, a memory Y02, and interface(s) for connecting various components, including high-speed interface(s) and low-speed interface(s). The various components are connected to each other by using different buses, and may be installed on a common motherboard or installed in other manners as required. The processor may process instructions executed in the electronic device, including instructions stored in or on the memory to display graphical information of GUI (Graphical User Interface) on an external input/output device (such as a display device coupled to an interface). In other embodiments, a plurality of processors and/or a plurality of buses may be used with a plurality of memories, if necessary. Similarly, a plurality of electronic devices may be connected in such a manner that each device providing a part of necessary operations (for example, as a server array, a group of blade servers, or a multi-processor system). In FIG. 4, a processor Y01 is illustrated by way of example.

The memory Y02 is a non-transitory computer-readable storage medium provided by the present disclosure. The memory stores instructions executable by at least one processor, to cause the at least one processor to perform the method of predicting the emotional style of the dialogue provided in the present disclosure. The non-transitory computer-readable storage medium of the present disclosure stores computer instructions for allowing a computer to execute the method of predicting the emotional style of the dialogue provided in the present disclosure.

The memory Y02, as a non-transitory computer-readable storage medium, may be used to store non-transitory software programs, non-transitory computer-executable programs and modules, such as program instructions/modules corresponding to the method of predicting the emotional style of the dialogue in the embodiments of the present disclosure. The processor Y01 executes various functional applications and data processing of the server by executing the non-transient software programs, instructions and modules stored in the memory Y02, thereby implementing the method of predicting the emotional style of the dialogue in the embodiments of the method mentioned above.

The memory Y02 may include a program storage area and a data storage area. The program storage area may store an operating system and an application program required by at least one function. The data storage area may store data etc. generated by using the electronic device according to the method of predicting the emotional style of the dialogue. In addition, the memory Y02 may include a high-speed random access memory, and may further include a non-transitory memory, such as at least one magnetic disk storage device, a flash memory device, or other non-transitory solid-state storage devices. In some embodiments, the memory Y02 may optionally include a memory provided remotely with respect to the processor Y01, and such remote memory may be connected through a network to the electronic device for the method of predicting the emotional style of the dialogue. Examples of the above-mentioned network include, but are not limited to the Internet, intranet, blockchain network, local area network, mobile communication network, and combination thereof.

The electronic device may further include an input device Y03 and an output device Y04. The processor Y01, the memory Y02, the input device Y03 and the output device Y04 may be connected by a bus or in other manners. In FIG. 4, the connection by a bus is illustrated by way of example.

The input device Y03 may receive input information of numbers or character, and generate key input signals related to user settings and function control of the electronic device, such as a touch screen, a keypad, a mouse, a track pad, a touchpad, a pointing stick, one or more mouse buttons, a trackball, a joystick, and so on. The output device Y04 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an application specific integrated circuit (ASIC), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

These computing programs (also referred as programs, software, software applications, or codes) include machine instructions for a programmable processor, and may be implemented using high-level programming languages, object-oriented programming languages, and/or assembly/machine languages. As used herein, the terms “machine-readable medium” and “computer-readable medium” refer to any computer program product, apparatus and/or device (for example, magnetic disk, optical disk, memory, programmable logic device (PLD)) for providing machine instructions and/or data to a programmable processor, including a machine-readable medium for receiving machine instructions as machine-readable signals. The term “machine-readable signal” refers to any signal for providing machine instructions and/or data to a programmable processor.

In order to provide interaction with the user, the systems and technologies described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), a blockchain network, and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host. It is a host product in the cloud computing service system to solve shortcomings of difficult management and weak business scalability existing in the traditional physical host and VPS (Virtual Private Server) service. The server may be a cloud server, a server of a distributed system, or a server in combination with block chains.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the protection scope of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of predicting an emotional style of a dialogue, comprising:
acquiring a context of a dialogue to be processed, from a text containing the dialogue;
acquiring a character information of the dialogue, wherein the character information indicates a speaker of the dialogue; and
predicting the emotional style of the dialogue according to the context and the character information.

2. The method of claim 1, further comprising:
traversing dialogues in the text to determine each of the dialogues in the text as the dialogue to be processed.

3. The method of claim 1, further comprising:
determining a content within quotation marks in the text as a dialogue; and/or
determining, for any content in the text, whether the content is a dialogue, by using a pre-trained classification model.

4. The method of claim 1, wherein the acquiring a character information of the dialogue comprises:
acquiring the character information of the dialogue that is manually labeled; or
predicting the character information of the dialogue by using a pre-trained character prediction model.

5. The method of claim 1, wherein the predicting the emotional style of the dialogue according to the context and the character information comprises:
constructing an input information, wherein the input information contains the context, the character information and the dialogue; and
inputting the input information into a pre-trained emotional style prediction model to predict the emotional style of the dialogue.

6. The method of claim 5, further comprising:
constructing training samples, wherein each training sample corresponds to a dialogue in a text, and contains the input information for the dialogue and a label indicative of the emotional style of the dialogue; and
training the emotional style prediction model by using the training samples.

7. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

8. A non-transitory computer-readable storage medium having computer instructions stored thereon, wherein the computer instructions are configured to cause a computer to implement the method of claim 1.
